(19) United States
(12) Patent Application Publication
(10) Pub. No.: US 2024/0392554 A1
(43) Pub. Date: Nov. 28, 2024

(54) A FIRST FLUSH DIVERTER SYSTEM

(71) Applicant: Rain Harvesting Pty Ltd, Milton (AU)

(72) Inventors: Shaun CROSSMAN, Milton (AU); Anton Liang LEE SEE, Camp Hill (AU); David ANDERSON, Milton (AU)

(73) Assignee: Rain Harvesting Pty Ltd, Milton, QL (AU)

(21) Appl. No.: 18/694,004

(22) PCT Filed: Sep. 16, 2022
(86) PCT No.: PCT/AU2022/051117

§ 371 Date: Mar. 21, 2024

(30) Foreign Application Priority Data
Sep. 23, 2021 (AU) 2021903063

(51) Int. Cl. E03F 7/00; E03B 3/02

(52) U.S. Cl. CPC E03F 7/00; E03B 3/02; E03F 2201/10

(57) ABSTRACT

A first flush diverter system, the system comprising an inlet supplying a fluid, a flush chamber comprising an opening through which fluid can pass, a retention chamber for containing a predetermined volume of fluid, and an outlet for conveying overflow fluid. The retention chamber is housed within the flush chamber, the retention chamber comprises a receiving aperture for receiving the fluid, and the retention chamber is configured to engageably seal the opening when the retention chamber contains the predetermined volume of fluid. The first flush diverter system overcomes limitations of flush storage containers, including the requirement to drain said flush storage containers.

### FIELD OF THE INVENTION

The present invention relates to a first flush diverter system, device, and/or method of use thereof.

### BACKGROUND TO THE INVENTION

Reference to background art herein is not to be construed as an admission that such art constitutes common general knowledge in Australia or elsewhere.

Diverter systems are commonly used in fluid collection and delivery systems for separating an initial flow of undesirable fluid. Typically, for rainwater collection systems, it is beneficial to separate an initial flow of contaminated rainwater from rainwater flowing from a collection area to a storage or usage area. This is because roofs and guttering systems can collect contaminants, including animal or bird droppings, dust, grit and other airborne material, all of which are carried by the initial flow of water during rainfall. These hazardous particles pose a particular threat to rainwater quality.

First flush diverter systems improve collected rainwater quality by minimising the volume of suspended and dissolved fine particles that end up in the rainwater tank. Existing first flush diverter systems typically utilise a T-junction to intercept the initial flow of water, with a vertical collection chamber comprising a float or valve that seals after the vertical collection chamber is full. These collection chambers require manual operation to drain the collected first flush fluid or may slowly drain over time. Such designs are also constrained by the physical size of collection chambers which determine the first flush volume. Large roof and gutter systems may therefore require multiple vertical collection chambers to adequately flush collected contaminants.

There is therefore a need for an improved first flush diverter system.

### OBJECT OF THE INVENTION

It is a preferred object of the invention to provide a system and/or an apparatus and/or a method that address or ameliorate one or more of the aforementioned problems of the prior art and/or provide a useful commercial alternative.

### SUMMARY OF THE INVENTION

The present invention relates to a first flush diverter system.

In one form, although not necessarily the broadest form, the invention resides in a first flush diverter system, the system comprising: an inlet supplying a fluid; a flush chamber comprising an opening through which fluid can pass; a retention chamber for containing a predetermined volume of fluid; and an outlet for conveying overflow fluid; wherein the retention chamber is housed within the flush chamber, the retention chamber comprises a receiving aperture for receiving the fluid, and the retention chamber is configured to engageably seal the opening when the retention chamber contains the predetermined volume of fluid.

In one embodiment, the retention chamber is spring biased away from sealing the opening.

In one embodiment, the retention chamber comprises an upper member, the upper member comprising the receiving aperture and is removably attached to the flush chamber.

In one embodiment, the retention chamber descends as the retention chamber receives fluid.

In one embodiment, the retention chamber comprises a lower member.

In one embodiment, the lower member descends as the retention chamber receives fluid.

In one embodiment, the first flush diverter system further comprises a directing member for directing the fluid towards the receiving aperture.

In one embodiment, the directing member comprises a geometric snoot.

In one embodiment, the receiving aperture comprises a grommet for receiving fluid, wherein the grommet for receiving fluid is sized to determine a rate of flow into the retention chamber for receiving the predetermined volume of fluid.

In one embodiment, the retention chamber further comprises a draining aperture for draining contained fluid.

In one embodiment, the draining aperture comprises a grommet for draining fluid, wherein the grommet for draining fluid is sized to determine a rate of flow for draining the contained fluid.

In one embodiment, the opening through which fluid can pass is a circular aperture and the retention chamber is centrally located within the circular aperture.

In one embodiment, the retention chamber comprises a skirt seal circumscribing a circumference of the retention chamber. Preferably, the skirt seal is located intermediate a top of the retention chamber and a bottom of the retention chamber. Preferably, the skirt seal extends laterally from a side wall of the retention chamber.

In one embodiment, the opening of the flush chamber allows between 20 to 40 litres of fluid to pass before the retention chamber engageably seals the opening.

In one embodiment, the opening of the flush chamber allows between 40 to 60 litres of fluid to pass before the retention chamber engageably seals the opening.

In one embodiment, the retention chamber further comprises a second draining aperture.

In one embodiment, a wick is configured to pass through the second draining aperture and draws out fluid from within the retention chamber.

In one embodiment, the inlet supplying the fluid conveys collected rainwater.

In one embodiment, the outlet for conveying overflow fluid conveys overflow fluid to a rainwater storage tank.

In one embodiment, the first flush diverter of the present invention is connected to a drain pipe through a T-piece such that a first flush of rainwater flowing through the drainpipe flows through the T-piece and into the flush container and when the retention chamber has received the predetermined volume of fluid, the retention chamber seals the opening and further rainwater is prevented from flowing through the opening.

In preferred embodiments of the present invention, when rain first starts to fall, rainwater and entrained dirt and other detritus from the roof flows down the gutter and into the drainpipes. Rainwater then flows into the flush chamber. The bulk of that rainwater passes through the flush chamber and flows to waste, but some of that rainwater flows into the retention chamber and starts to fill the retention chamber. As rain continues to fall, the retention chamber continually fills with water, this causes the retention chamber to lower or descend until the retention chamber seals the opening of the flush chamber. As further rainwater can no longer pass through the flush chamber, the flush chamber fills with water. Upon collection of sufficient rainwater in the flush chamber, any further rainwater collected from the roof then flows through piping and into a rainwater tank. In this manner, the first flush of dirty water is sent to waste and not to the rainwater tank.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a perspective view of a first flush diverter system in accordance with one embodiment of the present invention;

FIG. 2 is a section view of the first flush diverter system shown in FIG. 1;

FIG. 3 is a close-up section view of the first flush diverter system shown in FIG. 1, with a retention chamber in an unsealed position;

FIG. 4 is a close-up section view of the first flush diverter system shown in FIG. 1, with the retention chamber in a sealed position;

FIG. 4A is a close-up section view of the first flush diverter system shown in FIG. 1, with a wick;

FIG. 5 is an exploded view of the retention chamber of FIG. 1;

FIG. 6 is a perspective view of a directing member;

FIG. 7 is a top view of the directing member of FIG. 6;

FIG. 8 is a section view of the flush chamber of FIG. 1;

FIG. 9 is an exploded section view of the retention chamber of FIG. 1, with additional components;

FIG. 10 is a perspective view of a grommet for receiving fluid;

FIG. 11 is a perspective view of a grommet for draining fluid; and

FIG. 12 is a perspective view of a wick grommet and wick for draining fluid.

Skilled addressees will appreciate that the drawings may be schematic and that elements in the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE INVENTION

The present invention relates to a first flush diverter system. Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

According to one aspect, the present invention is defined as first flush diverter system, the system comprising: an inlet supplying a fluid; a flush chamber comprising an opening through which fluid can pass; a retention chamber for containing a predetermined volume of fluid; and an outlet for conveying overflow fluid; wherein the retention chamber is housed within the flush chamber, the retention chamber comprises a receiving aperture for receiving the fluid, and the retention chamber is configured to engageably seal the opening when the retention chamber contains the predetermined volume of fluid.

Advantages of some embodiments of the present invention include the ability to flush a large predetermined volume of fluid without necessitating storage containers matching the volume of flushed fluid. The invention also mitigates the need to manually drain the stored first flush fluid.

Those skilled in the art will appreciate that not all of the above advantages are necessarily included in all embodiments of the present invention.

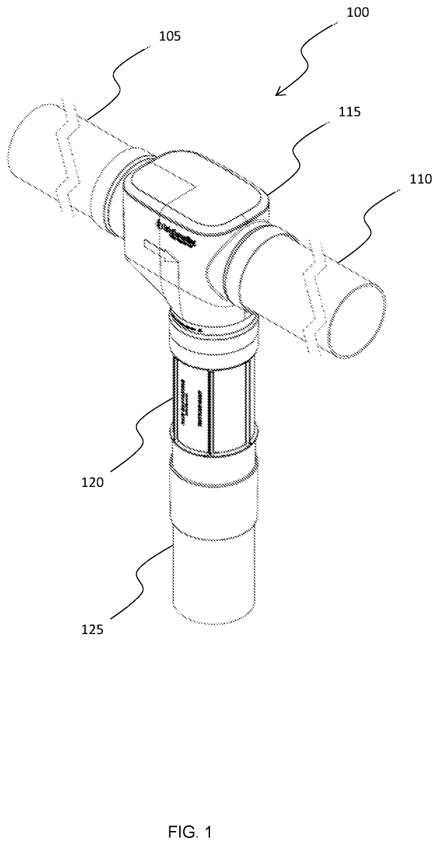

FIG. 1 is a perspective view of a first flush diverter system 100 in accordance with one embodiment of the present invention. The first flush diverter system 100 has an inlet for supplying a fluid, such as rainwater collected from a catchment region including a roof or a guttering system. The first flush diverter system 100 also comprises an outlet 110 for conveying the fluid to a collection container (not shown), such as a rainwater tank. An interception junction 115 shown in the form of a T-piece connection intercepts the fluid for redirection to a flush chamber 120. Preferably, the interception junction 115 intercepts the fluid and redirects the fluid by gravity so that the fluid falls toward the flush chamber 120. Fluid passing through the flush chamber can then exit through a drain 125 which is preferably connected to a stormwater system.

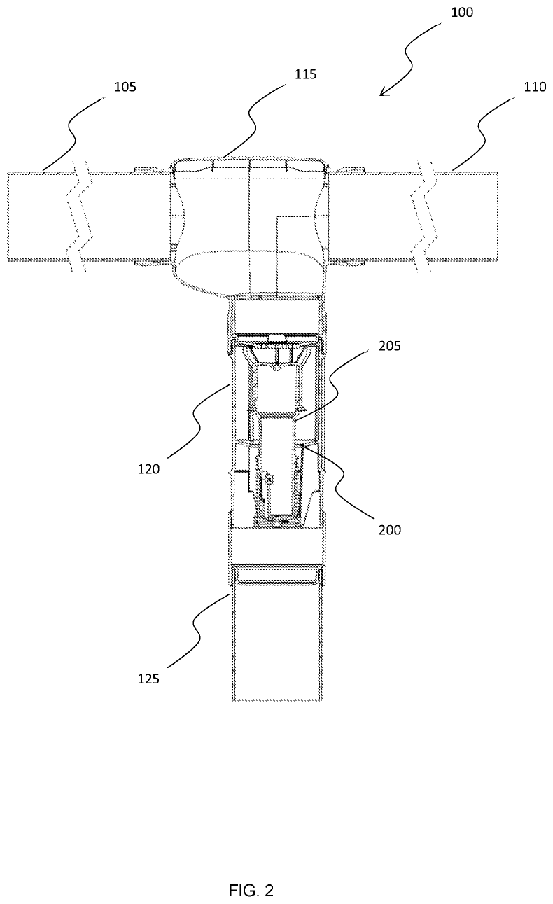

FIG. 2 is a section view of the first flush diverter system shown in FIG. 1. As shown, the flush chamber 120 comprises an opening 200 through which fluid can pass, allowing fluid to flow down towards the drain 125. The first flush diverter system 100 also comprises a retention chamber 205 housed within the flush chamber 120. The retention chamber 205 is configured to contain a predetermined volume of fluid, and when the retention chamber 205 contains the predetermined volume of fluid, the retention chamber 205 engages and seals the opening 200, halting the first flush process and preventing fluid from exiting through the opening. Once the opening is sealed and fluid is prevented from exiting through the opening, the fluid builds up toward the interception junction 115 and the outlet 110 conveys the overflow fluid toward the collection chamber such as a rainwater tank.

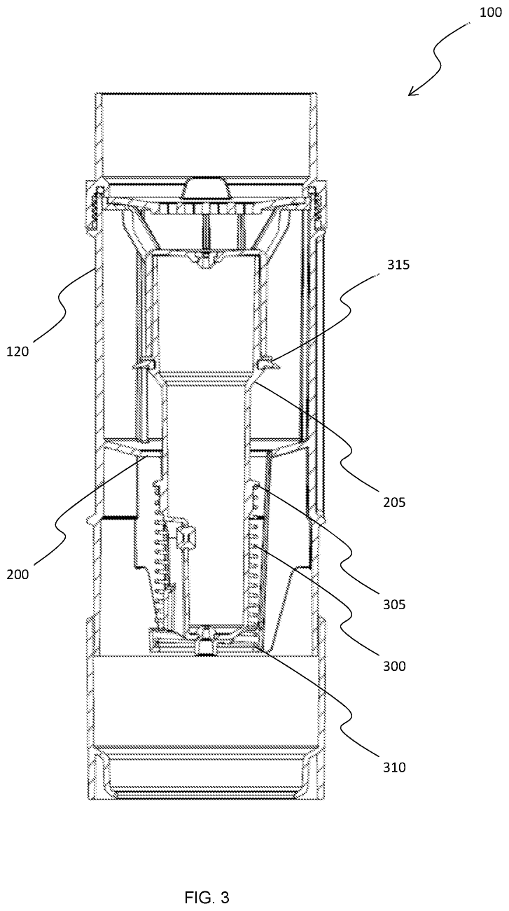

FIG. 3 is a close-up section view of the first flush diverter system 100 shown in FIG. 1, with the retention chamber 205 in an unsealed position and seated on a spring 300. An outwardly projection in the form of a circular rib 305 circumscribing the retention chamber locates the spring on the retention chamber 205, and a receiving face 310 on the flush chamber 120 abuts and seats the spring 300 in place. The retention chamber 205 also comprises a skirt seal 315 circumscribing a circumference of the retention chamber 205. The retention chamber 205 is thereby spring biased away from sealing the opening 200, as the spring 300 pushes the circular rib 305 and lifts the retention chamber 205 upward so that the skirt seal 315 is disengaged from the opening 200.

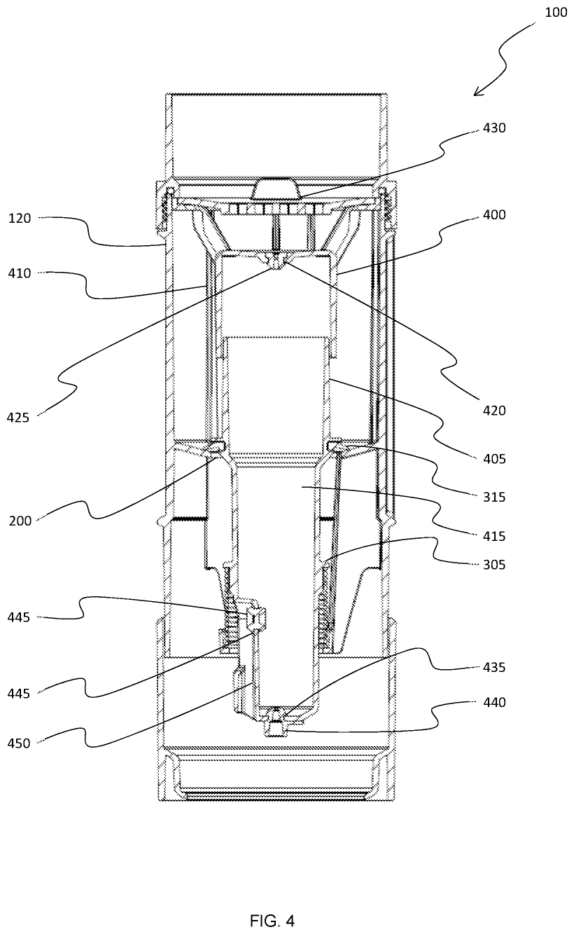

FIG. 4 is a close-up section view of the first flush diverter system 100 shown in FIG. 1, with the retention chamber 205 in a sealed position. As shown, the retention chamber 205 may comprise an upper member 400 and a lower member 405. In a preferred embodiment, the upper member 400 is fixed to the flush chamber 120. Optionally, ribs 410 on the flush chamber 120 abuts the upper member 400 and allows the upper member 400 to be seated in place and removably attached to the flush chamber 120. Preferably, the lower member 405 moves independently of the upper member 400, and the lower member 405 comprises the skirt seal 315 and circular rib 305 locating the spring 300. The lower member 405 is thereby able to move up and down against the bias of the spring 300 while the upper member 400 remains fixed in place. Accordingly, as the fluid fills an internal chamber 415 of the lower member 405, the weight of the lower member 405 increases. The lower member 405 thereby descends as the retention chamber 205 receives fluid. In other embodiments, the upper member and the lower member of the retention chamber can move together.

Preferably, the retention chamber 205 comprises a receiving aperture 420 for receiving the fluid. Further preferably, the receiving aperture 420 is located on the upper member 400, and the receiving aperture 420 comprises a grommet for receiving fluid 425. The grommet for receiving fluid 425 is sized to determine a rate of flow for receiving the predetermined volume of fluid and can be replaced with grommets of varying sizes to speed up or slow down fluid intake. To ensure that a consistent volume of fluid is falling on the receiving aperture 420, the first flush diverter system 100 further comprises a directing member 430 for directing the fluid towards the receiving aperture 420.

Preferably, the retention chamber 205 further comprises a draining aperture 435 for draining contained fluid. The draining aperture 435 also comprises a grommet for draining fluid 440. The grommet for draining fluid 440 is sized to determine a rate of flow for draining the predetermined volume of fluid and can be replaced with grommets of varying sizes to speed up or slow down fluid drainage. Optionally, the retention chamber 205 further comprises a second draining aperture 445 to assist with draining the retention chamber 205.

FIG. 4A is a close-up section view of the first flush diverter system shown in FIG. 1, with a wick 455. The second draining aperture 445 may be suitably located on a flat side wall 450 of the lower member 405, wherein the wick 455 is configured to pass through the second draining aperture 445 to draw out fluid from within internal chamber 415 the retention chamber 205. Further optionally, the second draining aperture 445 may comprise a wick grommet 460. In some embodiments, the retention chamber drains through the bottom aperture 435 and the second aperture 445 may be omitted or plugged or otherwise sealed. Similarly, in embodiments where the retention chamber drains through aperture 445, the bottom aperture 435 may be omitted or plugged or otherwise sealed. In a preferred embodiment, when the wick 455 is used to drain and draw out fluid from within the retention chamber 205, the bottom aperture 435 is plugged with a sealed grommet 465 that does not comprise a draining hole or aperture.

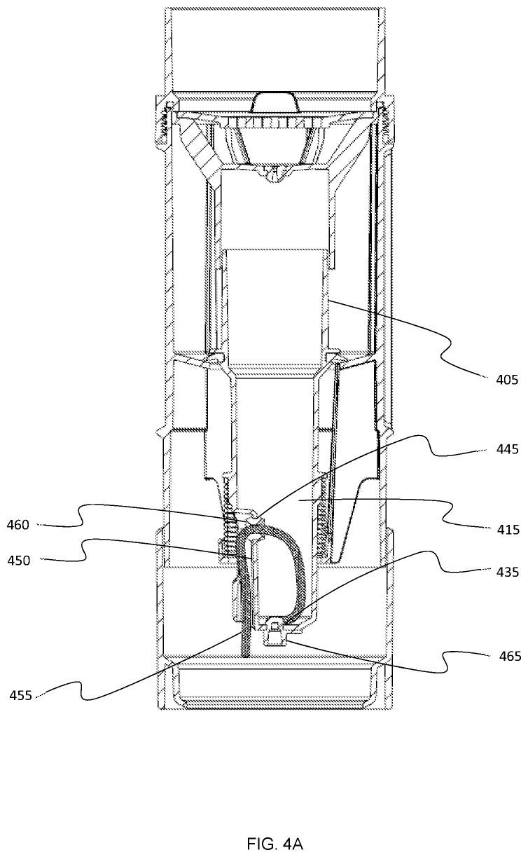

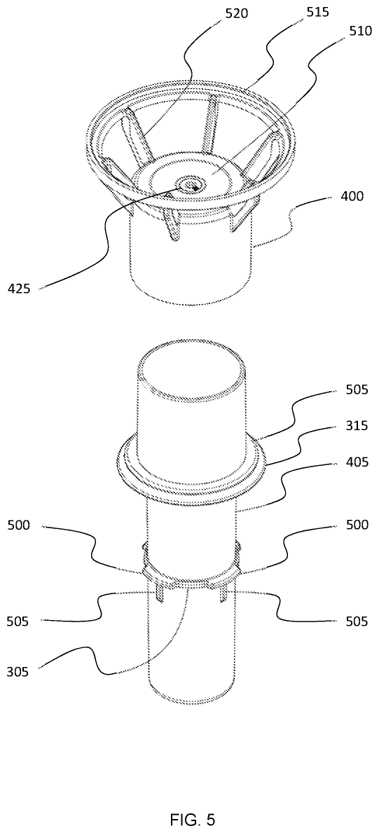

FIG. 5 is an exploded view of the retention chamber 205 of FIG. 1, clearly showing the separated upper member 400 and lower member 405. As shown, the circular rib 305 locating the spring 300 may comprise protrusions 500 and ribs 505 to further assist with retaining and locating the spring. The skirt seal 315 is located under a skirt flange 505 circumscribing the lower member 405, such that the skirt flange 505 provides evenly distributed pressure to the skirt seal 315 when engaging the opening 200. In a preferred embodiment, the upper member 400 and lower member 405 are substantially cylindrical, forming a cylindrical retention chamber 205. The opening 200 through which fluid can pass is preferably a circular aperture and the retention chamber 205 is centrally located within the circular aperture of the opening 200.

As shown, the upper member 400 comprises the receiving aperture 420 for receiving the fluid. Preferably, the receiving aperture 420 is located on top of the upper member 400, and the top of the upper member 400 comprises a dished surface 510 so that fluid is encouraged to flow towards the receiving aperture 420. The upper member also preferably comprises a circular collar 515 that is offset from the top of the upper member 400, and the circular collar 515 is supported by protruding arms 520. The underside of the circular collar 515 engages the ribs 410 of the flush chamber 120, and the topside of the circular collar 515 is configured to receive the directing member 430.

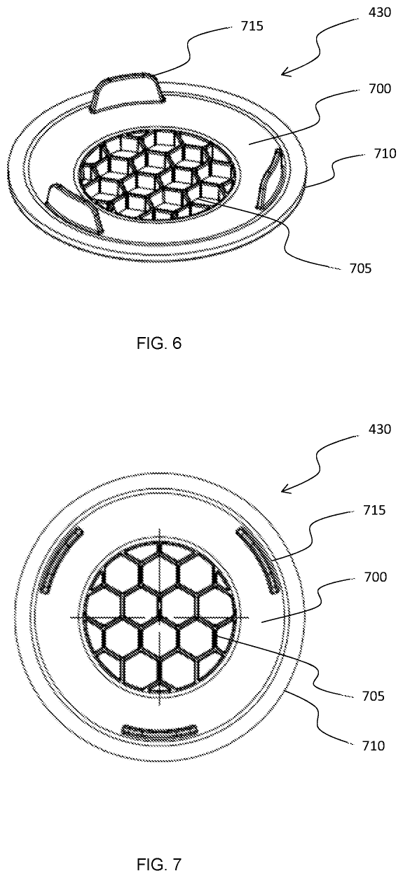

FIG. 6 is a perspective view of the directing member 430, and FIG. 7 is a top view of the directing member 430. The directing member 430 also comprises a dished surface 700 that encourages fluid to flow towards the centre of the directing member 430. The centre of the directing member 430 comprises a geometric snoot 705 to ensure that fluid passing through the directing member 430 is directed towards the receiving aperture 430 located on the upper member 400. Further preferably, the geometric snoot 705 is a honeycomb snoot that directs fluid perpendicularly towards the receiving aperture 430 below. The directing member 430 may comprise a lip 710 configured to engage and mate with the circular collar 515 of the upper member 400. The directing member 430 may further comprise protruding tabs 715 which provide additional purchase when manually adjusting or removing the directing member 430, such as for cleaning and changing the grommet for receiving fluid 425, or for access to the retention chamber 205.

FIG. 8 is a section view of the flush chamber 120 of FIG. 1. As shown, ribs 305 stop short of the top of the flush chamber 120, providing space for the circular collar 515 of the upper member, allowing the upper member 400 to be seated and flush with the top of the flush chamber. The opening 200 of the flush chamber 120 is also defined by an angled flange 800 to assist with allowing fluid to pass, as well as providing an even seal when engaged by the skirt seal 315 of the retention chamber 205.

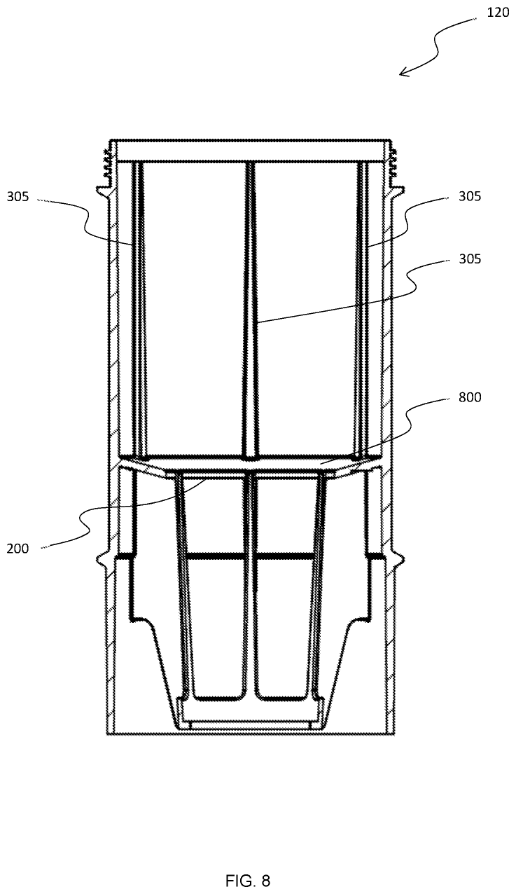

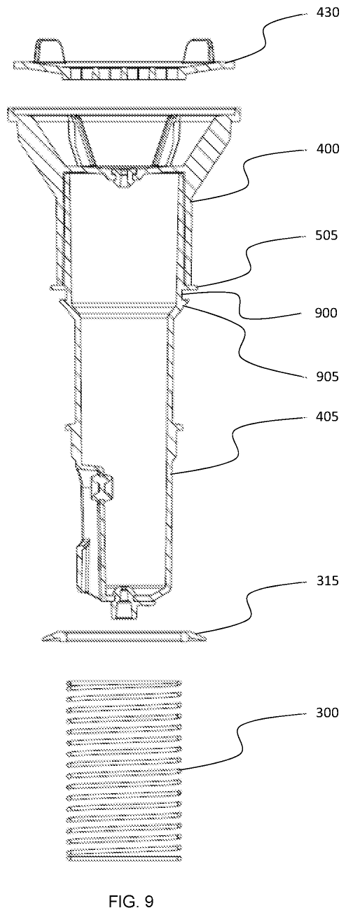

FIG. 9 is an exploded section view of the retention chamber of FIG. 1, with additional components that were omitted in the exploded view of FIG. 5. As best shown in FIG. 9, the skirt seal 315 may be located in a recessed channel 900 under the skirt flange 505 which assists with compression of the skirt seal against the opening 200. To assist with assembly and retention of the skirt seal 315, the lower member 405 may further comprise an angled ramp 905 circumscribing the lower member 405.

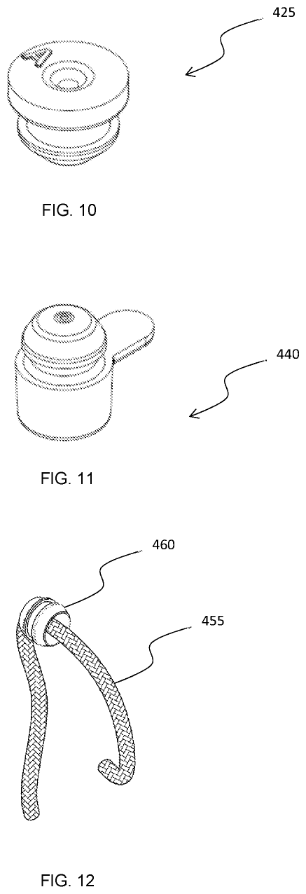

FIG. 10 is a perspective view of a grommet for receiving fluid 425 and FIG. 11 is a perspective view of a grommet for draining fluid 440. By varying the size of the grommet for receiving fluid 425, the first flush diverter system 100 can be configured such that the opening 200 of the flush chamber 120 allows a predetermined volume of fluid to pass before the retention chamber 205 engageably seals the opening 200. In a preferred embodiment, the flush chamber 120 allows between 20 to 40 litres of fluid to pass before the retention chamber 205 engageably seals the opening 200. In such instance, the grommet for receiving fluid 425 allows the retention chamber 205 to fill at a rate wherein the retention chamber 205 contains the predetermined volume of fluid after 20 to 40 litres of fluid have passed through the flush chamber 120. This volume can be fine tuned according to user preference, with lower volumes for smaller catchment surfaces such as domestic roofs, and higher volumes for larger catchment areas such as industrial warehouses. In a further embodiment, the flush chamber 120 allows between 40 to 60 litres of fluid to pass before the retention chamber 205 engageably seals the opening 200. As discussed, this volume can be increased according to catchment area to optimise volume of flushed fluid and, where necessary, increase to a volume beyond 60 litres. The skilled person will appreciate that the volume of water that is allowed to pass can vary from the stated amounts.

Once the retention chamber 205 engageably seals the opening 200, water building up within the flush chamber 120, which provides further compression on the skirt flange 505, ensures a tight seal of the skirt seal 315 against the opening 200. Further rainfall then fills the flush chamber 120 and fills pipping located above the flush chamber 120 until the water level reaches the bottom of drainpipe 110. At this time, further rainwater collected from the roof flows through drainpipe 110 into a rainwater collection device, such as a rainwater tank.

After the supply of fluid from the inlet has stopped, such as occurs when it stops raining, the predetermined volume of fluid in the retention chamber 205 and fluid contained within the flush chamber 120 keeps pressure on the spring 300 and maintains the seal of the opening 200. The grommet for draining fluid 440 slowly drains fluid from within the retention chamber, and can be optionally or alternatively aided by the second draining aperture 445 comprising the wick 455 passing through the wick grommet 460. The drainage speed determined by the size of the grommet for draining fluid 440 establishes a reset time before the seal disengages from the opening. Once the pressure on the skirt seal 315 provided by the predetermined volume of fluid within the retention chamber 205 and fluid contained within the flush chamber 125 is reduced and the seal is broken, the fluid contained within the flush chamber 125 quickly drains.

The first flush diverter system 100 therefore addresses at least some of the aforementioned problems, providing an effective first flush diverter that allows adjustment of first flush volume while maintaining small real estate and footprint. As a first flush diverter, the present invention removes the need of flush storage containers which limit the volume of first flush fluid, as well as the need to drain said flush storage containers. During prolonged periods of very light rain, the first flush diverter system 100 according to the present invention also avoids flush storage containers being filled up before substantial rain washes off contaminants from the catchment surface, which may inadvertently direct unwanted material into the rainwater storage tank.

In this patent specification, adjectives such as first and second, left and right, top and bottom, up and down, upper and lower, rear, front and side, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

The above description of various embodiments of the present invention is provided for purposes of description to one of ordinary skill in the related art. It is not intended to be exhaustive or to limit the invention to a single disclosed embodiment. Numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the scope of the above described invention, which is determined by the following claims.

1. A first flush diverter system, the system comprising:
an inlet supplying a fluid;
a flush chamber comprising an opening through which fluid can pass;
a retention chamber for containing a predetermined volume of fluid; and
an outlet for conveying overflow fluid;
wherein the retention chamber is housed within the flush chamber, the retention chamber comprises a receiving aperture for receiving the fluid, and the retention chamber is configured to engageably seal the opening when the retention chamber contains the predetermined volume of fluid.

2. The first flush diverter system of claim 1, wherein the retention chamber is spring biased away from sealing the opening.

3. The first flush diverter system of claim 1, wherein the retention chamber comprises an upper member, the upper member comprising the receiving aperture and is removably attached to the flush chamber.

4. The first flush diverter system of claim 1, wherein the retention chamber comprises a lower member.

5. The first flush diverter system of claim 4, wherein the lower member descends as the retention chamber receives fluid.

6. The first flush diverter system of claim 1, further comprising a directing member for directing the fluid towards the receiving aperture.

7. The first flush diverter system of claim 6, wherein the directing member comprises a geometric snoot.

8. The first flush diverter system of claim 1, wherein the receiving aperture comprises a grommet for receiving fluid, wherein the grommet for receiving fluid is sized to determine a rate of flow for receiving the predetermined volume of fluid.

9. The first flush diverter system of claim 1, wherein the retention chamber further comprises a draining aperture for draining contained fluid.

10. The first flush diverter system of claim 9, wherein the draining aperture comprises a grommet for draining fluid, wherein the grommet for draining fluid is sized to determine a rate of flow for draining the contained fluid.

11. The first flush diverter system of claim 1, wherein the opening through which fluid can pass is a circular aperture and the retention chamber is centrally located within the circular aperture.

12. The first flush diverter system of claim 1, wherein the retention chamber comprises a skirt seal circumscribing a circumference of the retention chamber.

13. The first flush diverter system of claim 1, wherein the opening of the flush chamber allows between 20 to 40 litres or 40 to 60 litres of fluid to pass before the retention chamber engageably seals the opening.

14. The first flush diverter system of claim 1, wherein the retention chamber further comprises a second draining aperture.

15. The first flush diverter system of claim 14, wherein a wick is configured to pass through the second draining aperture and draws out fluid from within the retention chamber.

16. The first flush diverter system of claim 1, wherein the inlet supplying the fluid conveys collected rainwater.

17. The first flush diverter system of claim 1, wherein the outlet for conveying overflow fluid conveys overflow fluid to a rainwater storage tank.
